(19) United States
(12) Patent Application Publication
(10) Pub. No.: US 2019/0150356 A1
(43) Pub. Date: May 23, 2019

(54) PARTICULATE MATERIAL DISTRIBUTION APPARATUS AND METHOD

(71) Applicant: Salford Group Inc., Salford (CA)

(72) Inventors: Geof J. Gray, Burford (CA); John Mark Averink, Norwich (CA); Bradley William Baker, Stratford (CA); Jesse Abram Dyck, London (CA); Arie Frank Bulk, Otterville (CA)

(21) Appl. No.: 16/316,786

(22) PCT Filed: Jun. 29, 2017
(86) PCT No.: PCT/CA2017/050790

§ 371 Date: Jan. 10, 2019

Related U.S. Application Data
(60) Provisional application No. 62/361,122, filed on Jul. 12, 2016.

(51) Int. Cl. A01C 15/00; A01C 15/12; A01C 21/00; A01C 7/10; E01C 19/20; E01H 10/00

(52) U.S. Cl. CPC A01C 15/006; A01C 15/122; E01H 10/007; A01C 7/102; E01C 19/205; A01C 21/005

(57) ABSTRACT

An apparatus for distributing particulate material has a plurality of independently weighed hoppers from which particulate materials are metered into a common collector and distributed to the environment with a common venture air system. Metering devices associated with at least two of the hoppers may be oriented in a face-to-face configuration.

### CROSS-REFERENCE TO RELATED APPLICATIONS

This application claims the benefit of United States Provisional Patent Application U.S. Ser. No. 62/361,122 filed Jul. 12, 2016, the entire contents of which is herein incorporated by reference.

### FIELD

This application relates to apparatuses and methods for distributing particulate material from more than one hopper using a venturi air system.

### BACKGROUND

The distribution of particulate material into the environment is a necessary component of a number of different operations including spreading salt, sand or other material on roadways, and spreading seed and/or fertilizer in agricultural fields. In many cases, it is desirable to be able to distribute more than one type of particulate immediately sequentially or during the same operation using the same equipment. In addition, it is often desirable to be able to independently determine the amounts of different particulate material being used and/or to be able to accurately alter the mix of different particulate materials being distributed simultaneously.

There remains a need to be able to perform two or more of such functions using common spreading equipment and to be able to change functions on the fly without changing equipment.

### SUMMARY

In one aspect, there is provided an apparatus for distributing particulate material, the apparatus comprising: a first hopper for containing a first particulate material, the first hopper comprising a first feed outlet for the first particulate material; a first weighing device operatively connected to the first hopper configured to weigh the first hopper; a second hopper for containing a second particulate material, the second hopper comprising a second feed outlet for the second particulate material; a second weighing device operatively connected to the second hopper configured to weigh the second hopper independently of the first hopper; a first metering device configured to receive the first particulate material from the first feed outlet; a second metering device configured to receive the second particulate material from the second feed outlet; a collector disposed proximate the first and second metering devices, the collector having a common inlet configured to receive particulate material metered from both the first and second metering devices, the collector having an exit port through which the particulate material exits the collector; and, a venturi air system in communication with the exit port of the collector for receiving the particulate material from the collector and distributing the particulate material to the environment.

In another aspect, there is provided an apparatus for distributing particulate material, the apparatus comprising: a first hopper for containing a first particulate material, the first hopper comprising a first feed outlet for the first particulate material; a second hopper for containing a second particulate material, the second hopper comprising a second feed outlet for the second particulate material; a first metering device configured to receive the first particulate material from the first feed outlet; a second metering device configured to receive the second particulate material from the second feed outlet; a collector disposed proximate the first and second metering devices, the collector having a common inlet configured to receive particulate material metered from both the first and second metering devices, the first metering device facing the second metering device with the first and second particulate materials being metered toward each other as the metering devices meter the particulate materials into the common inlet, the collector having an exit port through which the particulate material exits the collector; and, a venturi air system in communication with the exit port of the collector for receiving the particulate material from the collector and distributing the particulate material to the environment.

The hoppers are storage containers for particulate material. There may be 2, 3, 4 or more hoppers, each one containing the same or different particulate material than any one or more of the other hoppers. The hoppers may be supported on transportation, for example a truck, trailer or the like, the transportation comprising a frame supported on wheels to permit transportation of the distribution apparatus from place to place. Some examples of transportation include, for example, seed carts, fertilizer carts and hybrid seed/fertilizer carts for agricultural applications, and salt/sand spreader trucks for road safety applications. The hoppers may be supported on the frame of the transportation. The transportation may comprise one or more frames for supporting the hoppers and/or for being supported on the wheels.

In some embodiments, the hoppers are not connected rigidly together. A lack of rigid connection between the hoppers facilitates independent weighing of the individual hoppers. In one embodiment, the first and second hoppers may be disposed adjacent to each other, for example supported adjacent to each other on the frame of the transportation. In another embodiment, the second hopper may be disposed within the first hopper.

The weighing devices may be mechanical or electronic, preferably electronic. There may be one or more weighing devices for weighing any given hopper, for example there may be 1, 2, 3, 4 or more weighing devices per hopper. In one embodiment, at least one of the weighing devices may comprise a load cell system supporting one of the hoppers. Each hopper may be supported on its own load cell system. The load cell system may comprise one or more load cells, for example 1, 2, 3, 4 or more load cells. The load cells may be mounted on the frame with the hoppers supported freely on their respective load cells so that the load cells measure the weight of their respective hoppers independently. As particulate material is fed out of the hopper, the weight loss as measured by the weighing devices is a measure of the amount of particulate material being fed from the hopper and the amount of particulate material remaining in the hopper.

The hoppers may be open top or closed, but the contents of the hoppers are not required to be under pressure. Particulate material may be gravity fed through feed outlets on the hoppers to respective metering devices associated with each hopper. Each metering device may independently comprise one or more metering elements, preferably rotatable metering elements. Rotatable metering elements include, for example, meter rollers and/or endless belts. Meter rollers include, for example pegged output rollers, fluted output rollers, high output rollers, etc. The metering elements may be housed in housings, each housing comprising one or more metering inlets configured to receive particulate material from the respective hoppers and one or more metering outlets configured to deliver particulate material to the collector. In one embodiment, the first metering device faces the second metering device with the first and second particulate materials being metered toward each other as the metering devices meter the particulate materials into the common inlet of the collector. A face-to-face arrangement of metering devices is particularly advantageous because the arrangement avoids the necessity to stack metering systems, which avoids needing to reduce the size of one of the hoppers to accommodate stacked metering systems thereby maximizing the size of both hoppers.

At least the first and second metering devices meter particulate material into a collector through a common inlet of the collector. The collector may be disposed below the metering devices in order to receive a gravity feed of the particulate material. In one embodiment, the collector has no ultimate rigid attachment to more than one hopper so that the hoppers remain independently weighable. If the collector was ultimately attached to more than one hopper, then at least a portion of the weight of one hopper could be transferrable to another hopper, which would create difficulty for weighing the hoppers independently. In one embodiment the metering devices are attached to respective hoppers, and the collector may be attached to one metering device or neither metering device, but not to more than one metering device. In one embodiment, the collector may comprise a funnel. The funnel may have a large opening at a top acting as the common inlet and tapering side walls to direct the particulate material to one or more exit ports at a bottom of the funnel. The one or more exit ports may feed particulate material to one or more airstreams in one or more air lines of the venturi air system.

The venturi air system preferably comprises air lines (e.g. hoses) and an air moving device (e.g. a fan) for providing airstreams in the air lines. At least one of the airstreams flowing in the air lines is configured to receive the particulate material from the exit port of the collector and entrains the particulate material exiting the collector to carry the particulate material to outlet ports in the air lines, thereby distributing the particulate material to the environment. In one embodiment, the particulate material exits the collector in a direction substantially perpendicular to a direction of flow of the airstream. The venturi air system does not require pressurizing the hoppers. One or more air lines may be employed providing one or more airstreams in which particulate material may be carried to the outlet ports. Each airstream may be carried in separate air lines. There may be one or more than one metering element in a given metering device associated with each airstream, so a single airstream may receive product from one or more than one metering element of a given metering device. Because the collector is common to the metering devices, a single air system has the ability to distribute particulate material from different hoppers at different times using common airstreams, to distribute particulate material from different hoppers using different airstreams or to distribute particulate material from different hoppers at the same time using common airstreams. The one or more outlet ports of the air lines may be located on any desired implement, for example booms, tillage implements, seed drills, fertilizer drills and the like.

The ability to distribute particulate material from different hoppers at the same time using common airstreams permits mixing of different particulate material in a common airstream for simultaneous distribution to the same location in the environment. Adjusting the metering rate of each particulate material can adjust the proportion of different particulate materials in the same airstream being delivered to the same location at the same time. Such adjustments may be made on the fly, the nature of the adjustment depending on environmental conditions (e.g. soil conditions) or other considerations. The particulate material may comprise seed, fertilizer and the like for agricultural applications, or road salt, sand and the like for road safety applications.

The apparatus may further comprise a control system to control one or more of the air moving device, shut-off valves in the apparatus (e.g. between individual hoppers and their metering devices, in the exit ports of the collector, in the air lines, etc.) and the rate of feed of the particulate material from individual metering devices to the collector. The control system may also control any other aspect of the apparatus. Of especial importance is the ability to control the rate of feed of particulate material from any given hopper to the collector for reasons discussed above.

The control system may comprise a computer, an output device and an input device, the computer comprising a microprocessor, for example a programmable microprocessor, for controlling operations and a non-transient electronic storage medium for storing information about the weight of the hoppers, the type of particulate materials in the hoppers, metering rates of the particulate materials, other operational parameters of the apparatus, and/or for storing computer executable code for carrying out instructions for implementing operations. The computer may further comprise a transient memory (e.g. random access memory (RAM)) accessible to the microprocessor while executing the code. A plurality of computer-based apparatuses may be connected to one another over a computer network system and geographically distributed. One or more of the computer-based apparatuses in the computer network system may comprise a microprocessor for controlling operations and a non-transient electronic storage medium for storing information as described above, and the computer-based apparatuses in the network may interact so that the apparatus may be controlled from remote locations. The output device may be a monitor, a printer, a device that interfaces with a remote output device or the like. The input device may be a keyboard, a mouse, a microphone, a device that interfaces with a remote input device or the like.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a schematic diagram of an apparatus for distributing particulate material, in which two independently weighed hoppers deliver particulate material to respective meter roller assemblies in a face-to-face configuration for delivery of the particulate material to a common funnel;

FIG. 1B depicts a magnified view of region A in FIG. 1A;

FIG. 2 depicts a schematic diagram of an apparatus for distributing particulate material, in which three independently weighed hoppers deliver particulate material to respective metering devices for delivery of the particulate material to a common funnel;

FIG. 3 depicts a schematic diagram of an apparatus for distributing particulate material, in which two independently weighed hoppers deliver particulate material to respective meter roller assemblies in a stacked configuration for delivery of the particulate material to a common funnel; and,

FIG. 4 depicts a schematic diagram of an apparatus for distributing particulate material in context of a seed and fertilizer cart.

### DETAILED DESCRIPTION

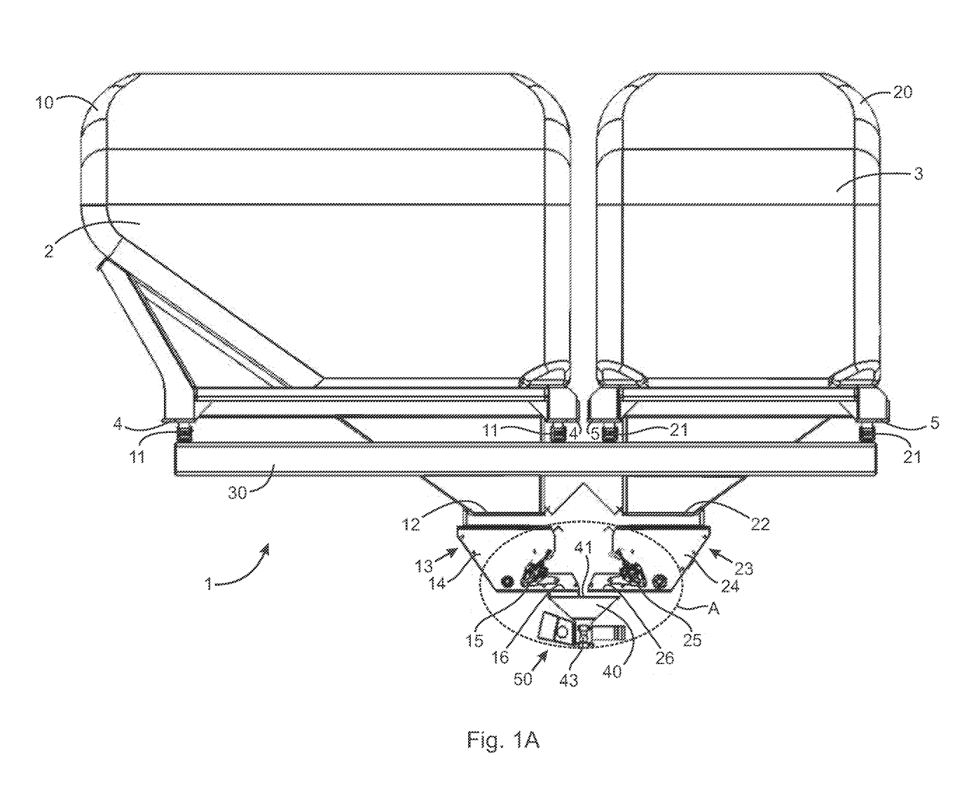

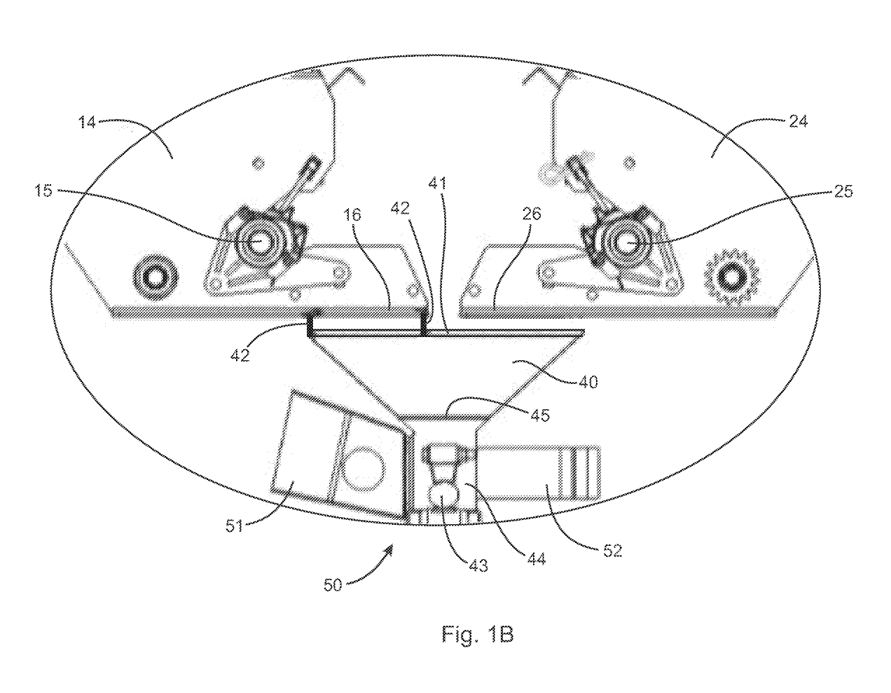

With reference to FIG. 1A and FIG. 1B, in one embodiment, an apparatus 1 for distributing particulate material, in particular seed and/or fertilizer, comprises a first hopper 10 and a second hopper 20 supported adjacent to each other on a frame 30 of a seed/fertilizer cart (not shown). The first hopper 10 contains a first particulate material 2 (e.g. seed or fertilizer) and is supported freely on the frame 30 by four load cells 11 (only two shown). Likewise, the second hopper 20 contains a second particulate material 3 (e.g. seed or fertilizer) and is supported freely on the frame 30 by four load cells 21 (only two shown). The hoppers 10, 20 are physically unattached to each other either directly or indirectly through the rest of the apparatus 1. The hoppers 10, 20 are supported on, but are not fixedly connected to, the load cells 11, 21 and the frame 30. The hoppers 10, 20 may be constrained from lateral movement by respective cradles 4, 5 so that the hoppers 10, 20 do not fall off the frame 30 while the apparatus is in motion. In one embodiment, the cradles may comprise bolts loosely inserted into threaded holes in the load cells, the threads of the bolts treated with a thread locker (e.g. Loctite™), and the bolts preventing the hoppers from moving about laterally. The load cells 11, 21 are in electronic communication with a control system (not shown), the load cells 11, 21 transmitting weight information about hoppers 10, 20, respectively, to the control system for processing and/or display on an output device of the control system.

The particulate materials 2, 3 in the hoppers 10, 20 are gravity fed through hopper outlets 12, 22, respectively, into respective first and second metering mechanisms 13, 23 attached to respective hoppers 10, 20 and disposed below the hopper outlets 12, 22. The first and second metering mechanisms 13, 23 comprise first and second meter boxes 14, 24, respectively, the first and second meter boxes 14, 24 housing first and second meter roller assemblies 15, 25, respectively. Each of the meter roller assemblies 15, 25 may comprise one or a plurality of meter rollers. The meter rollers of a given meter roller assembly may be driven on a common shaft or a plurality of shafts. Each of the meter boxes 14, 24 may have one or more cells that receive the particulate materials 2, 3 from respective hoppers 10, 20. The first and second meter boxes 14, 24 have one or more outlets 16, 26, respectively, from which the particulate materials 2, 3 are metered into a common upper opening 41 of a common funnel 40 disposed below the first and second metering mechanisms 13, 23. The first and second meter roller assemblies 15, 25 are configured in a face-to-face configuration so that the particulate material 2 from the first meter roller assembly 15 is metered toward the second meter roller assembly 25, and the particulate material 3 from the second meter roller assembly 25 is metered toward the first meter roller assembly 15. If both the first particulate material 2 and the second particulate material 3 are being metered simultaneously, the particulate materials 2, 3 fall together under the influence of gravity into the common upper opening 41 of the funnel 40 where they mix together.

The funnel may be fixedly connected to one or the other of the first and second meter boxes, or to neither but not to both. The funnel is not fixedly connected to both meter boxes to facilitate continued independent measurement of the weight of the hoppers by the load cells. In FIG. 1A and FIG. 1B, the funnel 40 is fixedly connected to the first meter box 14 by ties 42 so that the upper opening 41 of the funnel 40 is below both the first and second meter roller assemblies 15, 25 to receive the particulate materials 2, 3, respectively, being metered by the meter roller assemblies 15, 25. The funnel 40 further comprises a lower opening 43 through which the particulate materials 2, 3 exit the funnel 40. The lower opening 43 has smaller cross-sectional dimensions than the cross-sectional dimensions of the upper opening 41, thereby gathering the particulate materials 2, 3 for delivery through the lower opening 43 into a venturi air system 50. The funnel 40 comprises a lower chamber 44 into which the lower opening 43 opens. The lower chamber 44 is blocked from the upper opening 41 by a separating wall 45, although the lower chamber 44 and the upper opening 41 are in fluid communication through the lower opening 43. The lower chamber 44 is provided with apertures to which ports of the air system may be attached.

The venturi air system 50 comprises an air supply port 51 in fluid communication with the lower chamber 44 to which an air supply hose (not shown) may be attached for fluidly connecting the lower chamber 44 to a fan (not shown). The air system 50 also comprises an air delivery port 52 in fluid communication with the lower chamber 44 to which an air delivery hose (not shown) may be attached for fluidly connecting the lower chamber 44 to an outlet port (not shown) of the air delivery hose to deliver the particulate material to the environment. The air delivery port 52 is shown as being directly across the lower chamber 44 from the air supply port 51, but other arrangements may be possible. The particulate materials 2, 3 exit the lower opening 43 into the lower chamber 44 where the particulate materials 2, 3 are entrained in an airstream flowing from the air supply port 51 to the air delivery port 52, and then out through the outlet port of the air delivery hose. When the meter boxes comprise a plurality of cells, the funnel may comprise a plurality of compartments aligned with the plurality of cells for feeding the particulate materials into a plurality of lower chambers through a plurality of lower openings into air streams in a plurality of air hoses for distribution of the particulate materials out of a plurality of outlet ports distributed on an implement (e.g. a boom, tillage implement, drill or the like).

With the apparatus 1, different particulate materials may be metered into a common air system through a common funnel at different times for distribution separately into the environment. Also, without any changes to the apparatus 1, different particulate materials may be metered simultaneously into a common air stream for distribution simultaneously into the same location in the environment.

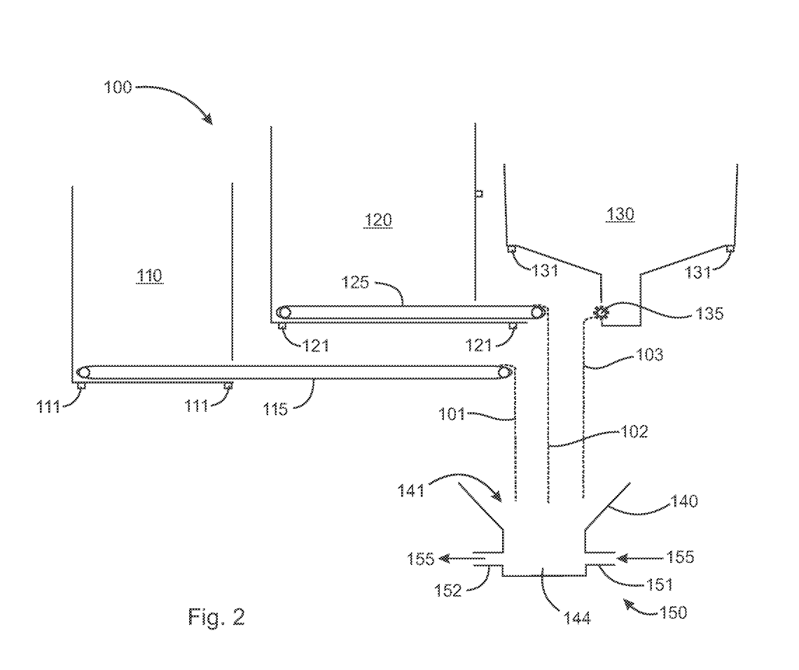

With reference to FIG. 2, an apparatus 100 for distributing particulate material is illustrated comprising first, second and third independently weighed hoppers 110, 120, 130, respectively, to deliver up to three different particulate materials 101, 102, 103 to a common funnel 140 into a common venturi air system 150 for delivery into the environment. The first hopper 110 is supported freely on a first set of load cells 111, which independently weigh the first hopper 110. The second hopper 120 is supported freely on a second set of load cells 121, which independently weigh the second hopper 120. The third hopper 130 is supported freely on a third set of load cells 131, which independently weigh the third hopper 130. The three sets of load cells 111, 121, 131 may be supported on a frame (not shown) and each of the three hoppers 110, 120, 130 may be supported on their respective sets of load cells 111, 121, 131 without being fixedly connected to the frame or any of the other hoppers.

In the apparatus 100, the particulate material 101 is metered from the first hopper 110 by a first endless belt 115, the particulate material 102 is metered from the second hopper 120 by a second endless belt 125, and the particulate material 103 is metered from the third hopper 130 by a meter roller 135. The endless belts 115, 125 meter particulate materials 101, 102, respectively, in a face-to-face configuration with the particulate material 103 metered by the meter roller 135. The common funnel 140 comprises a common upper opening 141 that receives the particulate materials 101, 102, 103, the particulate materials 101, 102, 103 being collected and funneled to a lower compartment 144 to be entrained in an airstream 155 flowing from an air supply port 151 to an air delivery port 152 connected to the lower compartment 144. Air flow is provided through hoses (not shown) by a fan (not shown), and particulate materials entrained in the airstream are carried in an air delivery hose connected to the delivery port 152 to be distributed to the environment through an outlet port of the air delivery hose. Like previously discussed, the particulate materials 101, 102, 103 from the first, second and third hoppers 110, 120, 130 may be metered at different times or simultaneously into the common funnel 140.

Where a plurality of endless belts and/or meter rollers are disposed with each hopper for metering the particulate materials to the funnel, the funnel may comprise a plurality of compartments aligned with the plurality of endless belts and/or meter rollers for feeding the particulate materials into a plurality of air streams in a plurality of air hoses for distribution of the particulate materials out of a plurality of outlet ports distributed on an implement (e.g. a boom, tillage implement, drill or the like).

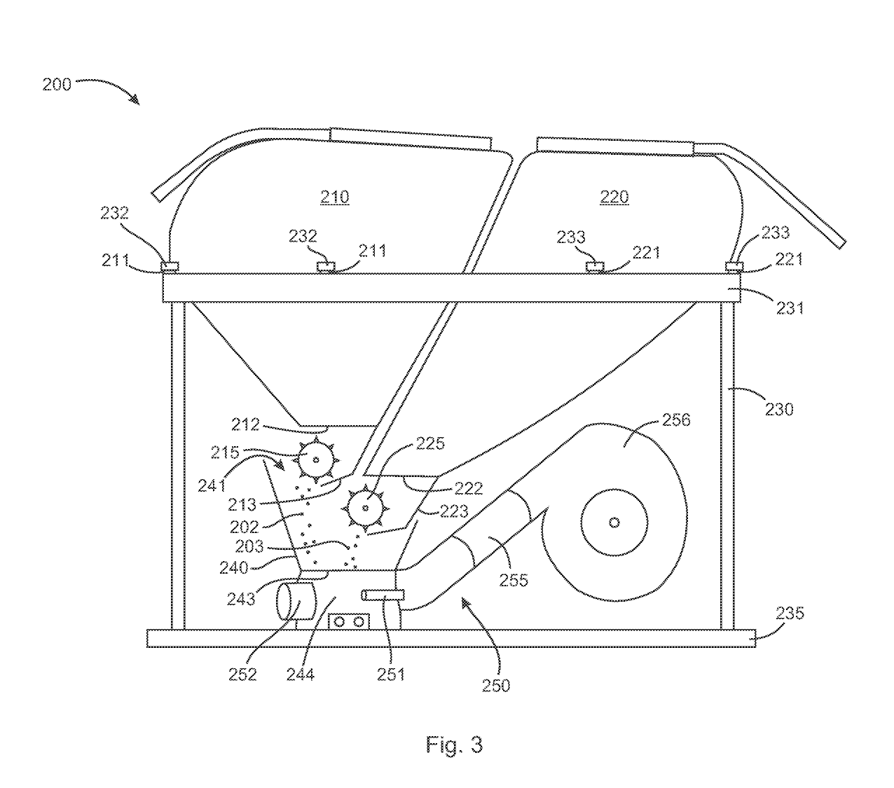

With reference to FIG. 3, in another embodiment, an apparatus 200 for distributing particulate material, in particular seed and/or fertilizer, comprises a first hopper 210 situated toward a front of a seed/fertilizer cart and a second hopper 220 supported adjacent and to a rear of the first hopper 210 on a frame 230 of the cart. The first hopper 210 contains a first particulate material 202 (e.g. seed or fertilizer) and is supported freely on horizontal frame members 231 (only one shown) of the frame 230 by engagement of four support flanges 232 (only two shown) with four load cells 211 (only two shown) mounted on the horizontal frame members 231. Likewise, the second hopper 220 contains a second particulate material 203 (e.g. seed or fertilizer) and is supported freely on horizontal frame members 231 (only one shown) of the frame 230 by engagement of four support flanges 233 (only two shown) with four load cells 221 (only two shown) mounted on the horizontal frame members 231. The support flanges 232, 233 are fixedly secured to the respective hoppers 210, 220 and rest on the respective load cells 211, 221 so that the entire weight of each hopper 210, 220 is borne by the respective load cells 211, 221. The hoppers 210, 220 are physically unattached to each other either directly or indirectly through the rest of the apparatus 200. The hoppers 210, 220 are supported on, but are not fixedly connected to, the load cells 211, 221 and the frame members 231. The hoppers 210, 220 may be constrained from lateral movement by the frame members 231 surrounding the hoppers 210, 220 are so that the hoppers 210, 220 do not fall off the frame 230 while the apparatus is in motion. The load cells 211, 221 are in electronic communication with a control system (not shown), the load cells 211, 221 transmitting weight information about hoppers 210, 220, respectively, to the control system for processing and/or display on an output device of the control system.

The particulate materials 202, 203 in the hoppers 210, 220 are gravity fed through hopper outlets 212, 222, respectively, into respective first and second metering mechanisms 213, 223 attached to respective hoppers 210, 220 and disposed below the hopper outlets 212, 222. The first and second metering mechanisms 213, 223 comprise first and second meter roller assemblies 215, 225, respectively. Each of the meter roller assemblies 215, 225 may comprise one or a plurality of meter rollers. The meter rollers of a given meter roller assembly may be driven on a common shaft or a plurality of shafts. As described in connection with FIG. 1, the metering mechanisms may comprise meter boxes, and each of the meter boxes may have one or more cells that receive the particulate materials from respective hoppers. The particulate materials 202, 203 are metered into a common funnel 240 disposed below the first and second metering mechanisms 213, 223. The first and second metering mechanisms 213, 223 are configured in a stacked configuration with the first metering mechanism 213 at a higher elevation that the second metering mechanism 223. If both the first particulate material 202 and the second particulate material 203 are being metered simultaneously, the particulate materials 202, 203 fall together under the influence of gravity into the common funnel 240 where they mix together.

The 240 funnel may be fixedly connected to lower horizontal frame members 235 (only one shown) so that the funnel 240 is not fixedly connected to either the first or second metering mechanisms 213, 223 to facilitate continued independent measurement of the weight of the hoppers 210, 220 by the load cells 211, 221. The funnel 240 further comprises a lower opening 243 through which the particulate materials 202, 203 exit the funnel 240. The lower opening 243 has smaller cross-sectional dimensions than the cross-sectional dimensions of an upper opening 241, thereby gathering the particulate materials 202, 203 for delivery through the lower opening 243 into a venturi air system 250. The funnel 240 comprises a lower chamber 244 into which the lower opening 243 opens. The lower chamber 244 is provided with apertures to which ports of the air system 250 may be attached.

The venturi air system 250 comprises an air supply port 251 in fluid communication with the lower chamber 244 to which an air supply hose 255 may be attached for fluidly connecting the lower chamber 244 to a fan 256. The air system 250 also comprises an air delivery port 252 in fluid communication with the lower chamber 244 to which an air delivery hose (not shown) may be attached for fluidly connecting the lower chamber 24 to an outlet port (not shown) of the air delivery hose to deliver the particulate material to the environment. The air delivery port 252 is shown as being directly across the lower chamber 244 from the air supply port 251, but other arrangements may be possible. The particulate materials 202, 203 exit the lower opening 243 into the lower chamber 244 where the particulate materials 202, 203 are entrained in an airstream flowing from the air supply port 251 to the air delivery port 252, and then out through the outlet port of the air delivery hose.

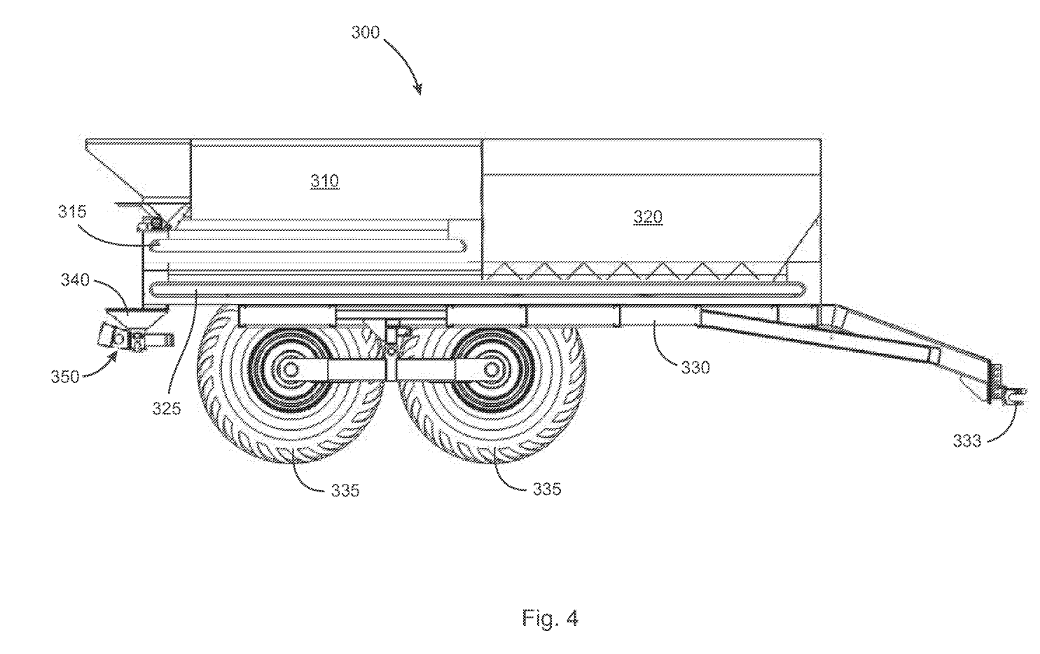

FIG. 4 depicts an apparatus 300 for distributing particulate materials in context of a seed and fertilizer cart. Here, the apparatus 300 is shown comprising a cart frame 330 supported on tandem wheels 335 and having a hitch 333 to permit towing the cart. Independently weighed first and second hoppers 310, 320, respectively, are supported on respective sets of load cells (not shown) mounted on the frame 330. A first endless belt 315 meters particulate material from the first hopper 310 and a second endless belt 325 disposed below the first endless belt 315 meters particulate material from the second hopper 320 so that the particulate materials from both hoppers 310, 320 are metered into a common opening of a common funnel 340. The funnel 340 is mounted on the frame 330, and collects the particulate materials metered from the first and second endless belts 315, 325 to deliver the particulate materials to a common venturi air system 350 for distribution in the environment. Like previously discussed, the particulate materials from the first and second hoppers 310, 320 may be metered at different times or simultaneously.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. An apparatus for distributing particulate material, the apparatus comprising:
a first hopper for containing a first particulate material, the first hopper comprising a first feed outlet for the first particulate material;
a first weighing device operatively connected to the first hopper configured to weigh the first hopper;
a second hopper for containing a second particulate material, the second hopper comprising a second feed outlet for the second particulate material;
a second weighing device operatively connected to the second hopper configured to weigh the second hopper independently of the first hopper;
a first metering device configured to receive the first particulate material from the first feed outlet;
a second metering device configured to receive the second particulate material from the second feed outlet;
a collector disposed proximate the first and second metering devices, the collector having a common inlet configured to receive particulate material metered from both the first and second metering devices, the collector having an exit port through which the particulate material exits the collector; and,
a venturi air system in communication with the exit port of the collector for receiving the particulate material from the collector and distributing the particulate material to the environment.

2. The apparatus according to claim 1, wherein the first and second hoppers are not connected rigidly together, and wherein the apparatus further comprises a frame supported on wheels wherein:
the first weighing device comprises a first load cell system mounted on the frame, the first hopper supported on the first load cell system; and,
the second weighing device comprises a second load cell system mounted on the frame, the second hopper supported on the second load cell system.

3. The apparatus according to claim 2, wherein the first load cell system comprises at least two load cells and the second load cell system comprises at least two load cells.

4. The apparatus according to claim 2, wherein the first and second hoppers are supported on the frame adjacent to each other.

5. The apparatus according to claim 1, wherein the first metering device faces the second metering device with the first and second particulate materials being metered toward each other as the metering devices meter the particulate materials into the common inlet of the collector.

6. The apparatus according to claim 1, wherein the second hopper is disposed within the first hopper.

7. The apparatus according to claim 1, wherein the first metering device comprises a meter roller or an endless belt and the second metering device comprises a meter roller or an endless belt.

8. The apparatus according to claim 1, wherein the collector comprises a funnel.

9. The apparatus according to claim 1, wherein the air system comprises air lines and a fan providing airstreams in the air lines, at least one of the airstreams configured to receive the particulate material from the exit port of the collector.

10. The apparatus according to claim 9, wherein the particulate material exits the collector in a direction substantially perpendicular to a direction of flow of the airstream.

11. The apparatus according to claim 1, further comprising:
a third hopper for containing a third particulate material, the third hopper comprising a third feed outlet for the third particulate material;
a third weighing device operatively connected to the third hopper configured to weigh the third hopper independently of the first and second hoppers; and,
a third metering device configured to receive the third particulate material from the third feed outlet, the third metering device configured to meter the third particulate material into the common inlet of the collector.

12. An apparatus for distributing particulate material, the apparatus comprising:
a first hopper for containing a first particulate material, the first hopper comprising a first feed outlet for the first particulate material;
a second hopper for containing a second particulate material, the second hopper comprising a second feed outlet for the second particulate material;
a first metering device configured to receive the first particulate material from the first feed outlet;
a second metering device configured to receive the second particulate material from the second feed outlet;
a collector disposed proximate the first and second metering devices, the collector having a common inlet configured to receive particulate material metered from both the first and second metering devices, the first metering device facing the second metering device with the first and second particulate materials being metered toward each other as the metering devices meter the particulate materials into the common inlet, the collector having an exit port through which the particulate material exits the collector; and,
a venturi air system in communication with the exit port of the collector for receiving the particulate material from the collector and distributing the particulate material to the environment.

13. The apparatus according to claim 12, wherein the first and second hoppers are supported on the frame adjacent to each other.

14. The apparatus according to claim 12, wherein the collector comprises a funnel.

15. A cart comprising an apparatus as defined in claim 1 supported thereon.
